(19) United States
(12) Patent Application Publication
(10) Pub. No.: US 2012/0086978 A1
(43) Pub. Date: Apr. 12, 2012

(54) CLOUD COMPUTING SYSTEM, INFORMATION PROCESSING METHOD, AND STORAGE MEDIUM

(75) Inventor: Shinichi Uchikawa, Kawasaki-shi (JP)

(73) Assignee: CANON KABUSHIKI KAISHA, Tokyo (JP)

(21) Appl. No.: 13/252,663

(22) Filed: Oct. 4, 2011

(30) Foreign Application Priority Data
Oct. 7, 2010 (JP) 2010-227576

(51) Int. Cl. G06F 3/12

(52) U.S. Cl. 358/1.15

(57) ABSTRACT

A cloud computing system may include a request receiving unit realized by executing a program that causes a storing service to store a message corresponding to a job according to reception of a processing request of the job from an image forming apparatus, and a back-end processing unit realized by executing a program that regularly issues to the storing service an acquisition request for the message. The cloud computing system further may include a registration unit and an instruction unit. The registration unit acquires a queue message issued according to a network pull-print request accepted from an image forming apparatus, determine a priority of the acquired queue message according to a status of the image forming apparatus, and register the queue message. The instruction unit acquires a queue message of high priority from registered queue messages and instruct the storing service to store the acquired queue message of high priority.

### BACKGROUND OF THE INVENTION

1. Field of the Invention

The present invention relates to a cloud computing system, an information processing method, and storage medium.

2. Description of the Related Art

Recently, techniques such as cloud computing system and Software as a Service (SaaS) have come into use for performing various processes on a server computer.

Cloud computing allows requests from a large number of clients to be processed at the same time by using a plurality of cloud resources (i.e., computing resources and storage resources) to perform distributed data conversion and data processing.

In such cloud computing system, there is emphasis on scalability. The cloud computing system is thus a system that employs “Availability (A)” and “partition tolerance (P)”at the expense of “consistency (C)” according to Brewer's CAP theorem.

For example, consistency is not assured in Windows (registered trademark) Azure. More specifically, a queue with respect to cloud computing in Windows Azure is not based on a “first in, first out (FIFO)” method, and the order of processing is not decided.

### SUMMARY OF THE INVENTION

According to an aspect of the present invention, a cloud computing system which includes a request receiving unit realized by executing a request receiving program that causes a storing service to store a message corresponding to a job according to reception of a processing request of the job from an image forming apparatus, and a back-end processing unit realized by executing a back-end processing program that regularly issues to the storing service an acquisition request for the message, and performs, in response to acquiring the message from the storing service, a process based on the acquired message, includes a registration unit configured to acquire a queue message issued according to a network pull-print request accepted by the request receiving unit from an image forming apparatus, determine a priority of the acquired queue message according to a status of the image forming apparatus, and register the queue message in request management data, and an instruction unit configured to acquire a queue message of high priority from queue messages registered by the registration unit, and instruct the storing service to store the acquired queue message of high priority.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration according to an exemplary embodiment.

FIG. 2 illustrates an example of a hardware configuration of an image forming apparatus according to an exemplary embodiment.

FIG. 3 illustrates an example of a hardware configuration of an information processing apparatus according to an exemplary embodiment.

FIG. 4 illustrates a conventional system.

FIG. 5 illustrates a processing request queue in a conventional network pull-print system.

FIG. 6 illustrates an example of a functional configuration of an entire system according to an exemplary embodiment.

FIG. 7 illustrates in detail a network pull-print system according to an exemplary embodiment.

FIGS. 8A, 8B, 8C, and 8D illustrate examples of a queue message management table.

FIG. 9 is a flowchart illustrating an example of a process performed by an image forming apparatus.

FIG. 10 is a flowchart illustrating a process performed by a network pull-print request/client information receiving unit.

FIGS. 11A, 11B, and 11C are flowcharts illustrating examples of a process performed by a queue message scheduler.

FIG. 12 is a sequence diagram illustrating an example of a process performed by the system according to an exemplary embodiment.

### DESCRIPTION OF THE EMBODIMENTS

Various exemplary embodiments, features, and aspects of the invention will be described in detail below with reference to the drawings.

A network pull-print service generated on the cloud computing system, which acquires document data designated by an image forming apparatus and converts the document data to a printable data format will be described below.

If a plurality of image forming apparatuses issue pull-print requests to such a network pull-print service, the requests are managed in a queue with respect to cloud computing. The order of processing the requests is thus not assured. As a result, a printing request which is subsequently issued from a user maybe processed before a print request issued first from another user is processed. In such a case, it becomes necessary for the user who issued the first print request to wait for a long time to print.

The embodiments solve such a problem, and allow the requests to be processed in a receiving order even in the cloud computing system.

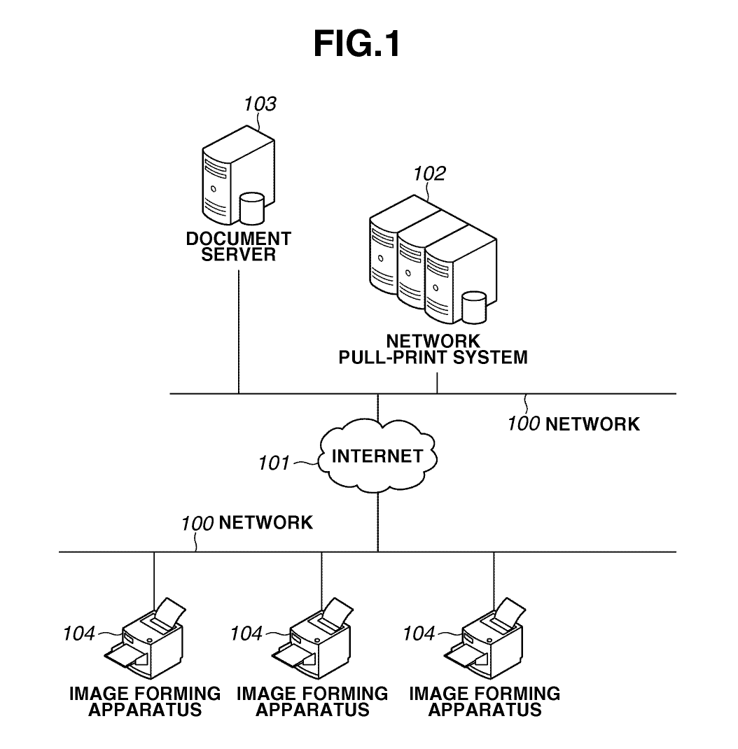

The apparatuses included in the network pull-print system will be described below with reference to FIG. 1. FIG. 1 illustrates an example of a system configuration. Referring to FIG. 1, each of the apparatuses included in the network pull-print service is connected via a network 100. The network system includes a network pull-print system 102, a document server 103, and an image forming apparatus 104.

The network 100 is a communication line for the above-described apparatuses to exchange information between each other. The Internet 101 is a communication line for the above-described apparatuses to exchange information between each other over a firewall. The Internet 101 allows the network 100 to which the image forming apparatuses 104 are connected, to communicate over the firewall with the network 100 to which the network pull-print system 102 are connected. For example, the network 100 and the Internet 101 configure a communication line network that supports transmission control protocol/Internet protocol (TCP/IP), and may be a wired or a wireless network. Further, the network pull-print system 102 is illustrated in FIG. 1 as a single server. However, the network pull-print system 102 may include a plurality of server computers.

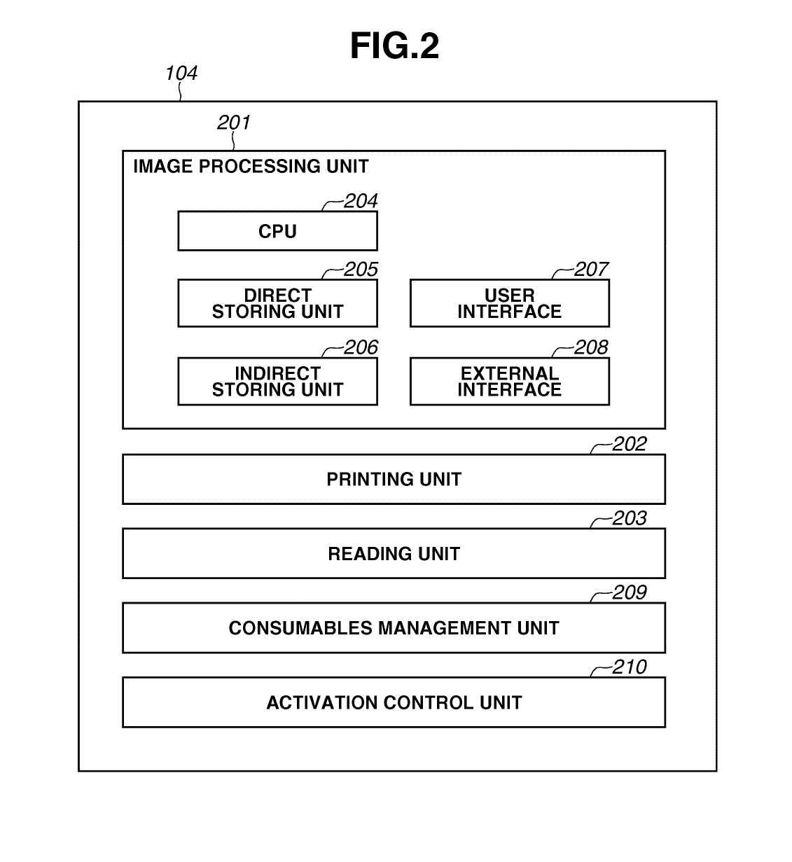

The internal configuration of each apparatus included in the network pull-print service illustrated in FIG. 1 will be described below. The hardware configuration of the image forming apparatus 104 will be described below with reference to FIG. 2.

Referring to FIG. 2, the image forming apparatus 104 includes an image processing unit 201, a printing unit 202, and a reading unit 203. The image processing unit 201 includes a central processing unit (CPU) 204, a direct storing unit 205, an indirect storing unit 206, a user interface 207, an external interface 208, and a consumables management unit 209.

The CPU 204 executes predetermined programs and instructs various control of the image forming apparatus 104. The direct storing unit 205 is a work memory used by the CPU 204 to execute the programs, and the programs to be executed by the CPU 204 are loaded to the direct storing unit 205. The direct storing unit 205 is realized by a random access memory (RAM). The indirect storing unit 206 stores various programs including application programs and platform programs. The various programs stored in the indirect storing unit 206 are transferred, when the CPU 204 executes the programs, to the direct storing unit 205. The indirect storing unit 206 is realized by a solid state drive (SSD) or a hard disk drive (HDD). The CPU 204 may be a multiprocessor.

A platform will be described below. By realization of the platform, the user becomes capable of executing a self-developed new application on the image forming apparatus 104, and also becomes capable of customizing an operation screen in the image forming apparatus 104.

A method for realizing the platform will be described below. The CPU 204 transfers a platform program stored in the indirect storing unit 206 to the direct storing unit 205. Upon completing the transfer, the CPU 204 becomes capable of executing the platform program. According to the present exemplary embodiment, the execution of the platform program by the CPU 204 is referred to as activation of the platform. The platform operates on firmware of the image forming apparatus 104. The platform program provides an environment for executing an object-orientated application program.

The application program is executed on the platform as described below. According to the present exemplary embodiment, print software which accepts print requests is operating on the platform. The print software can receive print data from a device connected via the network using a communication protocol such as a hypertext transfer protocol (HTTP). The print software then transmits the received print data to the firmware, and the firmware then starts processing the print data. If the print data can be printed without being processed, the firmware does not perform the print data processing. As described above, the image forming apparatus 104 can be controlled by executing the application program on the platform.

The method for executing the application program is as follows. The activated platform transfers the application program stored in the indirect storing unit 206 to the direct storing unit 205. Upon completion of the transfer, the platform can execute the application program, so that the platform executes the application program. According to the present exemplary embodiment, the function of the platform which can be provided by executing the application program will be referred to as a platform application. Further, the platform is capable of performing a portion of each of the processes illustrated in the flowcharts according to the present exemplary embodiments.

The user interface 207 is a unit necessary for receiving the processing requests from the user. For example, the user interface 207 receives a signal corresponding to an instruction input by the user via a keyboard or a mouse. The external interface 208 is capable of receiving and transmitting data from and to an external device. Examples of the external device are external storage devices such as an external HDD and an external universal serial bus (USB), and a separate apparatus such as a separate host computer or image forming apparatus connected via the network. The image forming apparatus 104 can communicate with the network pull-print system 102 via the network 100 and the Internet 101.

The consumables management unit 209 stores and manages consumables necessary for printing (e.g., toner, ink, and paper). If the consumables necessary for printing have run out (i.e., toner or ink run-out or paper run-out has occurred), the consumables management unit 209 issues a consumables run-out event. If the consumables are then replenished so that printing can be performed, the consumables management unit 209 issues a consumables replenishment event. The platform application can detect the consumables run-out event and the consumables replenishment event, and can thus execute the programs corresponding to the events.

An activation control unit 210 switches the image forming apparatus 104 between activation and termination. If the activation control unit 210 switches the image forming apparatus 104 to an activating state, the CPU 204 loads from the indirect storing unit 206 to the direct storing unit 205, which is the program necessary for realizing the activating state. The CPU 204 then executes the program, so that the image forming apparatus 104 is in an operable state. Upon completing the predetermined activation process, the program necessary for realizing the activating state issues an activation event. Further, if the activation control unit 210 switches the image forming apparatus 104 to a terminating state, the CPU 204 loads from the indirect storing unit 206 to the direct storing unit 205, which is the program necessary for terminating the image forming apparatus 104. The CPU 204 then executes the program, so that the image forming apparatus 104 is in an inoperable state. Upon completing the predetermined termination process, the program necessary for terminating the image forming apparatus 104 issues a termination event. The platform application can detect the activation event and the termination event, and can thus execute the programs corresponding to the events.

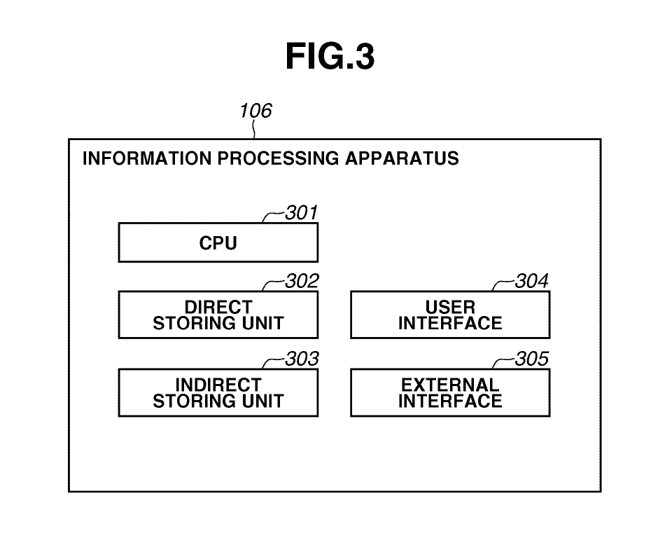

The hardware configuration of an information processing apparatus including the network pull-print system 102 and the document server 103 will be described below with reference to FIG. 3. Referring to FIG. 3, an information processing apparatus 106 includes a CPU 301, a direct storing unit 302, an indirect storing unit 303, a user interface 304, and an external interface 305.

The user interface 304 is a unit necessary for receiving the processing requests from the user. For example, the user interface 304 receives the signal corresponding to the instruction input by the user via the keyboard or the mouse.

The CPU 301 executes predetermined programs and instructs various types of control of the information processing apparatus 106. The direct storing unit 302, i.e., a RAM, is a work memory used by the CPU 301 to execute the programs, and the programs to be executed by the CPU 301 are loaded to the direct storing unit 302 . The indirect storing unit 303 such as a read-only memory (ROM) or the HDD stores various programs including the application programs and an operating system (OS). The various programs stored in the indirect storing unit 303 are transferred, when the CPU 301 executes the programs, to the direct storing unit 302. The external interface 305 is connected to the network 100 and can communicate with the other devices connected to the network 100.

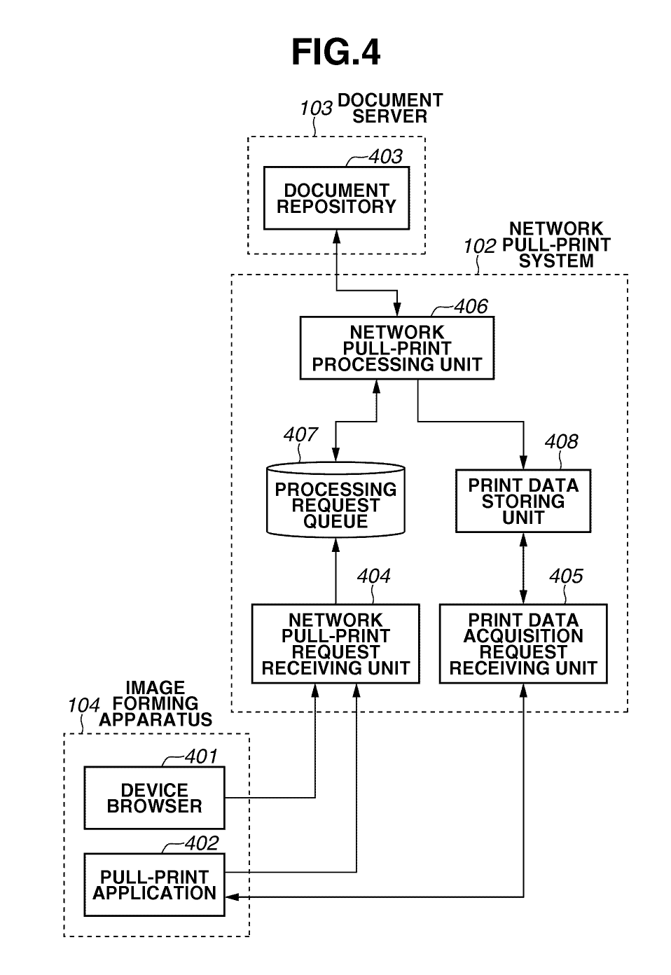

The function of the document server 103 will be described below. The document server 103 includes a function of a document repository 403 illustrated in FIG. 4 which is realized by the indirect storing unit 303. The document repository 403 stores the contents that the user instructs to print from the image forming apparatus 104.

The conventional image forming apparatus 104 will be described below with reference to FIG. 4. Referring to FIG. 4, the image forming apparatus 104 in the conventional system includes the functions of a device browser 401 and a pull-print application 402. The device browser 401 has a function for allowing the user to view the data and information stored in the devices connected via the network 100. The device browser 401 is realized by the CPU 204 loading a device browser program stored in the indirect storing unit 206 illustrated in FIG. 2 to the direct storing unit 205 and executing the program. Further, the user can instruct printing of the contents using the device browser 401. An example of the device browser 401 is a web browser.

The pull-print application 402 regularly confirms whether the print data has been generated with respect to a print data acquisition uniform resource identifier (URI) generated by a network pull-print request receiving unit 404. If the print data has been generated, the pull-print application 402 acquires and prints the print data.

The platform system of the network pull-print system 102 included in the conventional network pull-print service will be described below with reference to FIG. 4. The network pull-print request receiving unit 404 is a module that receives the network pull-print request from the image forming apparatus 104. The network pull-print request receiving unit 404 corresponds to a request receiving unit realized by executing a request receiving program. More specifically, the request receiving program causes the storing service to store a message corresponding to a job, according to receipt of a job processing request from the image forming apparatus.

The network pull-print request receiving unit 404 transmits via a processing request queue 407 the processing request to a network pull-print processing unit 406. The processing request queue 407 corresponding to the storing service provides a service for the network pull-print request receiving unit 404 and the network pull-print processing unit 406 to perform asynchronous data communication. The network pull-print request receiving unit 404 and the network pull-print processing unit 406 perform asynchronous data communication by issuing various instructions to the processing request queue 407. The network pull-print processing unit 406 regularly issues to the storing service a request for acquiring the message. Further, the network pull-print processing unit 406 corresponds to a back-end processing unit that is realized by executing a back-end processing program. More specifically, the back-end processing program performs, if the message is acquired from the storing service, a process according to the acquired message.

The network pull-print processing unit 406 thus acquires the queue message from the processing request queue 407, acquires the designated document, and converts the document to a data format printable by the image forming apparatus. The network pull-print processing unit 406 then stores the generated data printable by the image forming apparatus in a print data storing unit 408, associated with a print data acquisition URI to be used in acquiring the print data. Upon completing such processes, the network pull-print processing unit 406 issues to the processing request queue 407, an instruction to delete the queue message corresponding to the receiving identification (ID). Upon receiving the deletion request, the processing request queue 407 deletes from the queue the queue message corresponding to the receiving ID designated by the network pull-print processing unit 406.

The print data acquisition request receiving unit 405 is a module that receives the print data acquisition request from the image forming apparatus 104. The print data acquisition request receiving unit 405 confirms whether there is the print data with respect to the print data acquisition URI demanded by the image forming apparatus 104. If the print data of the designated URI exists in the print data storing unit 408, the print data acquisition request receiving unit 405 transmits the corresponding data stored in the print data storing unit 408 to the image forming apparatus.

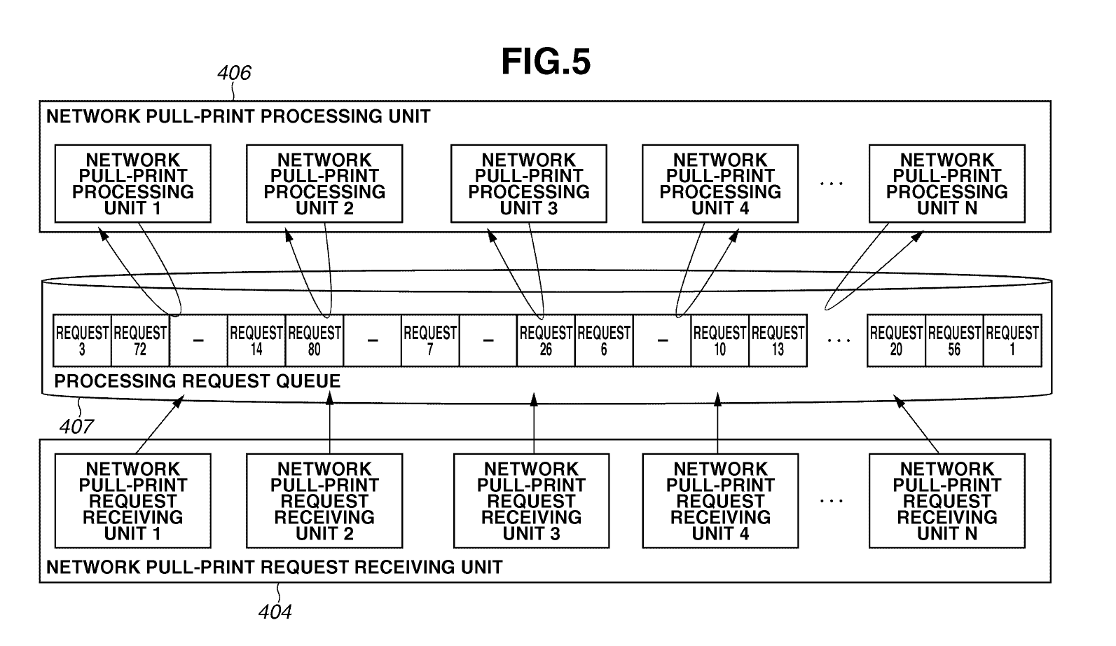

The processing request queue 407 in the platform system of the network pull-print system 102 included in the conventional network pull-print system will be described in detail below with reference to FIG. 5. The processing request queue 407 is similar to the queue in the cloud environment.

The network pull-print request receiving unit 404 instructs the processing request queue 407 to add a queue message. On the other hand, the network pull-print processing unit 406 instructs the processing request queue 407 to acquire and delete the queue messages. The queue message acquisition instruction is an operation for acquiring the queue message registered in the queue. The queue message deletion instruction is an operation for deleting the queue message from the queue. The information on the queue in the cloud environment is not deleted only by acquiring the queue message, and it is necessary to delete the queue message after completing the queue message processing.

The network pull-print request receiving unit 404 generates the information designated by the user as the queue message, and instructs the processing request queue 407 to add the queue message to the queue. The processing request queue 407 then adds the queue message to the internal queue. The queue message is added to a free space in the queue kept within the processing request queue 407.

On the other hand, the network pull-print processing unit 406 issues the acquisition instruction to the processing request queue 407 to acquire the queue message. The processing request queue 407 which receives the acquisition instruction acquires the queue message from an arbitrary position in the processing request queue. In such an acquisition process, the processing request queue 407 acquires the queue message from an arbitrary position in the processing request queue 407 instead of employing the FIFO method. In other words, the first queue message added to the processing request queue 407 in the system may be processed later than the subsequent queue message.

If the network pull-print processing unit 406 performs processing in a short period of time, such a change in the processing order is insignificant. However, an inconvenience caused by such a queue system increases as the processing time of the network pull-print processing unit 406 becomes longer. For example, if ten requests are accumulated in which the processing time for each request is one minute, when a new request is issued, by good luck the new request may be processed first. In such a case, it may become necessary for the user to wait for only one minute, which is the request processing time for the request. However, if such a state frequently occurs, the previously requested queue messages do not become processed, and it becomes necessary for the users who requested such queue messages to wait for a long time.

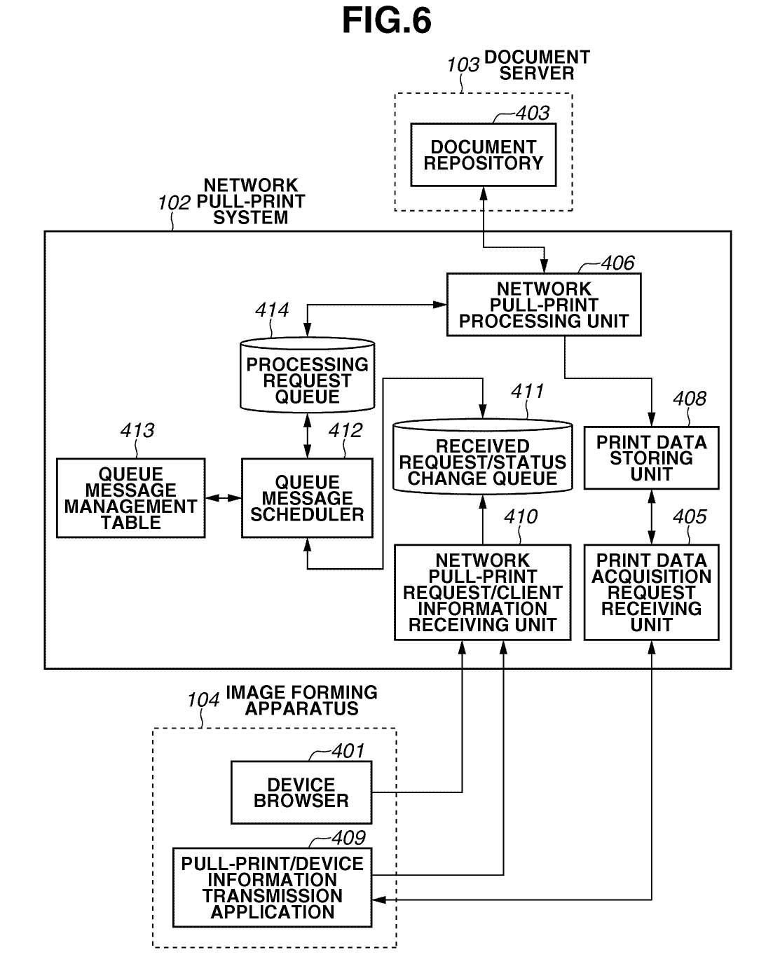

The platform system in the network pull-print system 102 included in the network pull print service according to the present exemplary embodiment will be described below with reference to FIG. 6.

Referring to FIG. 6, a network pull-print request/client information receiving unit 410 is a module that receives from the image forming apparatus 104 the network pull-print request and information on the image forming apparatus 104. For example, the information on the image forming apparatus 104 is a status of the printing unit in the image forming apparatus, such as “idle (ready to print)”, “processing (printing)”, and “error (cannot print)”. Further, the information on the image forming apparatus 104 may indicate a total processing time of all print jobs currently being requested, or time when the requested print data can be printed or performance of the image forming apparatus. The information on the image forming apparatus 104 is an example of image forming apparatus information.

According to the present exemplary embodiment, unless otherwise stated, the information on the image forming apparatus 104 is the status of the printing unit. Further, according to the present exemplary embodiment, there are two statuses of the printing unit, i.e., “cannot print (error)” and “ready to print (ready)”, for ease of description. However, these are not limitations on the present exemplary embodiment. Furthermore, the network pull-print request/client information receiving unit 410 will be simply referred to as the receiving unit 410, for ease of description.

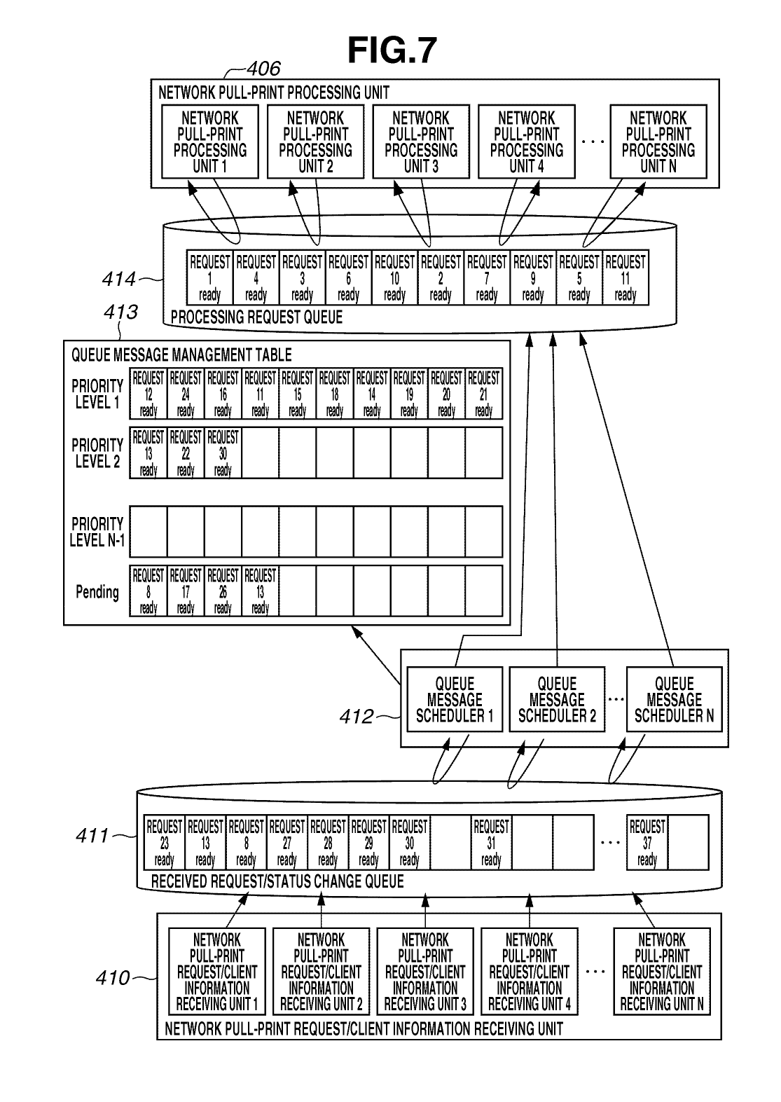

Upon receiving the network pull-print request and the status of the image forming apparatus 104, the receiving unit 410 notifies a received request/status change queue 411 of a request/status change. The received request/status change queue 411 is an example of a received request queue. The receiving unit 410 assigns the receiving order to the queue message according to the order in which the messages are received. For example, “xx” in a request “xx ready” illustrated in FIG. 7 to be described below corresponds to the receiving order.

A queue message scheduler 412 acquires the queue message from the received request/status change queue 411. The queue message scheduler 412 then confirms whether the message received from the image forming apparatus 104 is a print request or a requester information notification, and performs a process according to the message. The queue message scheduler 412 is an example of a scheduling unit.

Further, the queue message scheduler 412 confirms the status of a processing request queue 414. The queue message scheduler 412 then registers the queue message stored in a queue message management table 413, in the processing request queue 414, according to a job status of the processing request queue 414. The queue message management table 413 is an example of request management data. If the queue message scheduler 412 detects that the number of unprocessed jobs in the processing request queue 414 is less than a predetermined number, the queue message scheduler 412 acquires from the queue message management table 413 a queue message list of highest priority. The queue message scheduler 412 then registers in the processing request queue 414 the queue messages registered in the acquired queue message list. The queue message scheduler 412 deletes from the queue message management table 413 the queue messages registered in the processing request queue 414.

The network pull-print processing unit 406 then acquires the queue message from the processing request queue 414, acquires the designated document, and converts the document to the data format printable by the image forming apparatus. The network pull-print processing unit 406 stores in the print data storing unit 408, the data printable by the image forming apparatus, associated with the print data acquisition URI to be used for acquiring the print data.

Upon completing the above-described processes, the network pull-print processing unit 406 instructs the processing request queue 414 to delete the queue message corresponding to the receiving ID. The processing request queue 414 receiving the deletion instruction deletes from the queue the queue message corresponding to the receiving ID instructed by the network pull-print processing unit 406.

The print data acquisition request receiving unit 405 is a module that receives the print data acquisition request from the image forming apparatus 104. The print data acquisition request receiving unit 405 confirms the existence of the print data with respect to the print data acquisition URI demanded by the image forming apparatus 104.

If there is the print data of the designated URI in the print data storing unit 408, the print data acquisition request receiving unit 405 transmits the data stored in the print data storing unit 408 to the image forming apparatus.

The received request/status change queue 411, the queue message scheduler 412, the queue message management table 413, and the processing request queue 414 in the platform system of the network pull-print system 102 will be described in detail below with reference to FIG. 7. The received request/status change queue 411 and the processing request queue 414 are both similar to the queue in the cloud environment.

The receiving unit 410 issues to the received request/status change queue 411 the instruction to add the queue message. On the other hand, the queue message scheduler 412 instructs the received request/status change queue 411 to acquire and delete the queue message. The queue message acquisition instruction is an operation for acquiring the queue message registered in the queue. The queue message deletion instruction is an operation for deleting the queue message from the queue. Since the information on the queue in the cloud environment should not be deleted by only acquiring the queue message, it is necessary to delete the queue message after completing the process of the queue message.

The receiving unit 410 generates the queue message based on the information designated by the user. The information designated by the user is either a network pull-print request or a device status change notification. The receiving unit 410 then transmits to the received request/status change queue 411 the instruction to add the queue message.

Upon receiving the instruction to add the queue message, the received request/status change queue 411 adds the queue message to the internal queue. The queue message is added to an open space in the queue stored inside the received request/status change queue 411.

The queue message scheduler 412 issues the acquisition instruction to the received request/status change queue 411 to acquire the queue message. Upon receiving the acquisition instruction, the received request/status change queue 411 acquires the queue message from an arbitrary position in the processing request queue.

The received request/status change queue 411 does not acquire the queue message by employing the FIFO method. The first queue message added to the received request/status change queue 411 may thus be processed later than the subsequent queue message.

The queue message scheduler 412 confirms whether the queue message acquired from the received request/status change queue 411 is a request or a status change, and then performs the respective process. If the queue message is the print request, the queue message scheduler 412 determines the priority based on the receiving order and the information on the image forming apparatus 104 registered in the queue message. The queue message scheduler 412 then registers the queue message in the queue message management table 413 according to the priority.

The queue message management table 413 is a table that manages the received queue messages to which priorities have been set. The management table includes a list in which a plurality of queue messages is grouped according to the priority. The list is an example of a data list.

The queue message scheduler 412 registers in the processing request queue 414 the queue messages in a unit of the queue message list for each priority. As a result, the receiving order is maintained even when the processing order of the queue messages received from a client (i.e., the image forming apparatus) is random. Further, the above-described process can be used to determine the processing order based on processing priority in the present system, in addition to determining the receiving order. According to the present exemplary embodiment, the queue message scheduler 412 determines the priority based on the information on the image forming apparatus 104 for ease of description unless otherwise stated.

The queue message scheduler 412 acquires the number of unprocessed jobs in the processing request queue 414. If the number is less than a predetermined number, the queue message scheduler 412 adds to the processing request queue 414 the queue message list of highest priority from the queue message management table 413. The queue message scheduler 412 then deletes from the queue message management table 413 the queue messages registered in the processing request queue, and changes the highest priority list.

The network pull-print processing unit 406, the queue message scheduler 412, and the receiving unit 410 in the cloud computing system illustrated in FIG. 7 perform a plurality of tasks to perform distributed processing.

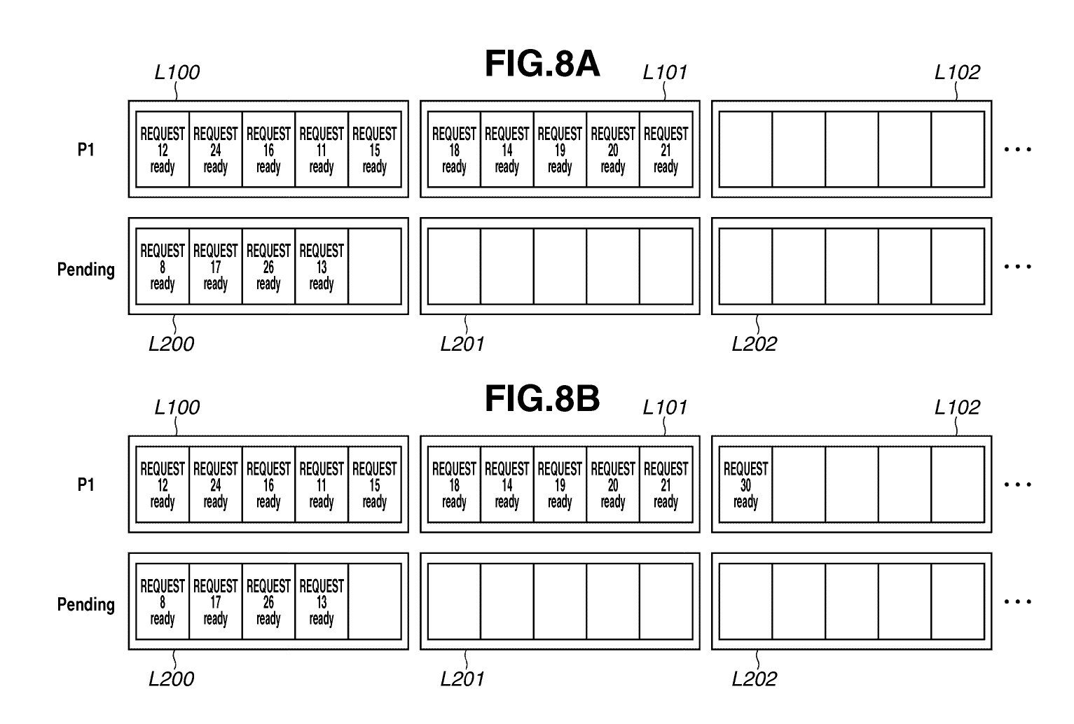

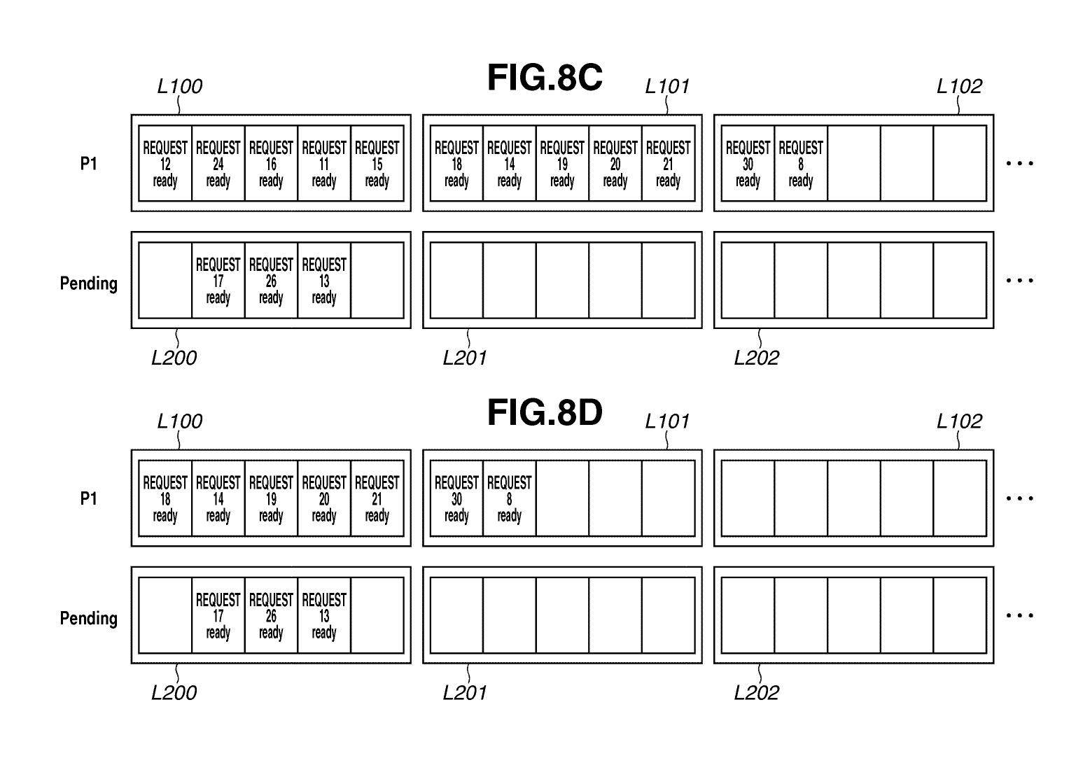

The method for managing the queue messages in the queue message scheduler 412 and the queue message management table 413 will be described below with reference to FIGS. 8A and 8B. According to the present exemplary embodiment, the queue messages are divided into two priorities. “P1” indicates the queue messages of high priority, and “Pending” indicates the queue messages of low priority.

The queue message management table 413 stores a plurality of lists, each of which manages the queue messages according to the two priorities. For example, the queue message management table 413 stores the lists L100, L101, L102, etc., that manage the queue messages of the priority “P1”. Further, the queue message management table 413 stores the lists L200, L201, L202, etc., that manage the queue messages of the priority “Pending”. Such queue message lists are of FIFO structure, and the P1 list is used in the order of L100, L101, and 102.

More specifically, it is assumed that the client has notified of the status of the printing units as the information on the image forming apparatus. The statuses of the printing unit are “cannot print (error)” and “ready to print (ready)”. If the status acquired from the client is “ready (to print)”, the queue message management table manages the queue message as “P1”. On the other hand, if the status of the client is “error (cannot print)”, the queue message management table manages the queue message as “Pending”.

It is then assumed in a management status illustrated in FIG. 8A that there is a new request of a receiving order number 30 in which the information on the image forming apparatus is “ready”. In such a case, since the information on the image forming apparatus is “ready”, the queue message scheduler 412 registers the request as priority “P1” in the queue message management table 413. Since there is no empty entry in the list L100 and the list L101 among the lists of priority “P1”, the request is registered in the list L102.

It is then assumed in the status illustrated in FIG. 8B that the image forming apparatus which requested the queue message of receiving order number 8 has issued a notification of changing the status to “ready”. In such a case, the queue message scheduler 412 searches for the queue message of the receiving order 8 in the queue message management table 413. If the queue message scheduler 412 detects the queue message of the receiving order number 8, the queue message scheduler 412 shifts the queue message to the “P1” queue message list corresponding to the notified “ready” status. Since there is no empty entry in the list L100 and the list L101 among the lists of priority “P1”, the request is registered in the list L102. For example, if the image forming status has recovered from a failure, the image forming apparatus issues a notification about change of the status from “error” to “ready”. The status is then changed from “error” to “ready”, and the priority of the queue message of an image forming layer is raised.

The process performed when the queue message scheduler 412 selects the queue message to be processed from the queue messages registered in the queue message management table 413 in the state illustrated in FIG. 8C will be described below. The process will be described in detail with reference to FIGS. 8C and 8D.

If the queue message scheduler 412 issues the processing request to the processing request queue 414, the queue message scheduler 412 acquires the list of requests of high priority from the queue message management table 413. Referring to FIG. 8C, the list L100 is the list of the requests of highest priority. Upon acquiring the list L100, the queue message scheduler 412 registers in the processing request queue 414 the requests of received order number 12, 24, 16, 11, and 15 registered in the list. The queue message scheduler 412 then deletes from the queue message management table 413 the queue messages registered in the processing request queue 414. As a result, the list L101 illustrated in FIG. 8C becomes the list of requests to be processed at highest priority in the “P1” queue messages. FIG. 8D illustrates the content of the resulting queue message management table 413.

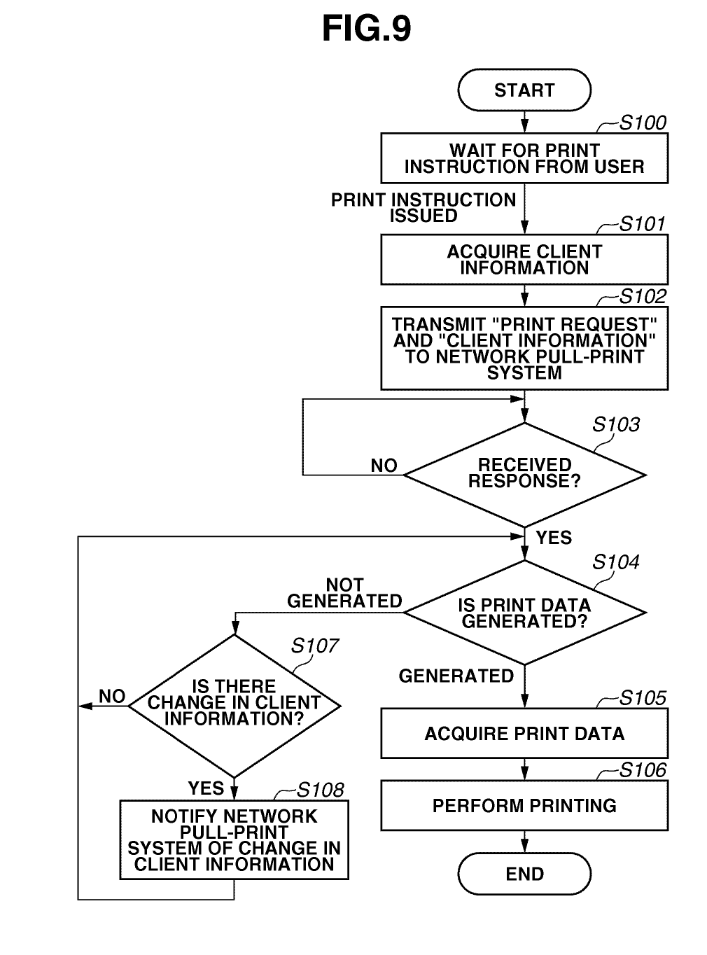

The process performed in the image forming apparatus 104, i.e., the client in the network pull-printing system, will be described below with reference to the flowchart illustrated in FIG. 9.

In step S100, the image forming apparatus 104 waits for a pull-print instruction from the user interface 304 in the device browser 401. In step S101, upon receiving the instruction, the image forming apparatus 104 acquires the information on the image forming apparatus. The information on the image forming apparatus is information to be used in the network pull-print system to determine the priority of the queue message. For example, the information on the image forming apparatus is the status of the printing unit in the image forming apparatus, a predicted time in which the image forming apparatus is to process the queue message, or a print performance or a product name of the image forming apparatus.

In step S102, the device browser 401 acquires the information on the image forming apparatus. The device browser 401 then notifies the receiving unit 410 in the network pull-print system 102 of print document information and client information, using a pull-print/device information transmission application 409 illustrated in FIG. 6. According to the embodiments, the pull-print/device information transmission application 409 will be simply referred to as the transmission application 409 for ease of description.

In step S103, the transmission application 409 determines whether a response to the transmitted request is received. If the transmission application 409 receives a response to the transmitted request (YES in step S103), the process proceeds to step S104. In step S104, the transmission application 409 confirms whether the print data is generated, with the data acquisition URL received as the response. If the print data has been generated (GENERATED in step S104), the process proceeds to step S105, and the image forming apparatus 104 acquires the print data. In step S106, the image forming apparatus 104 prints the print data.

On the other hand, if the print data has not been generated (NOT GENERATED in step S104), the process proceeds to step S107. In step S107, the transmission application 409 continues to confirm whether there is a change in the client information transmitted to the network pull-print system 102, until it is confirmed in step S104 that the print data has been generated. If there is no change in the client information (NO in step S107), the process returns to step S104, and the transmission application 409 reconfirms whether the print data has been generated. If the change in the client information is detected (YES in step S107), the process proceeds to step S108. Instep S108, the transmission application 409 notifies the receiving unit 410 in the network pull-print system 102 of the information on the change in the client.

For example, if the printing unit in the image forming apparatus, which has been operating normally when the request has been transmitted, stopped printing, the transmission application 409 transmits an error message as the client change information. The printing unit may have stopped printing due to toner or ink run-out, paper jam, or paper run-out. Further, the client change information maybe a notification that a print ready time of the image forming apparatus has been changed from the time initially notified to the receiving unit 410 in the network pull-print system 102 due to a job interruption.

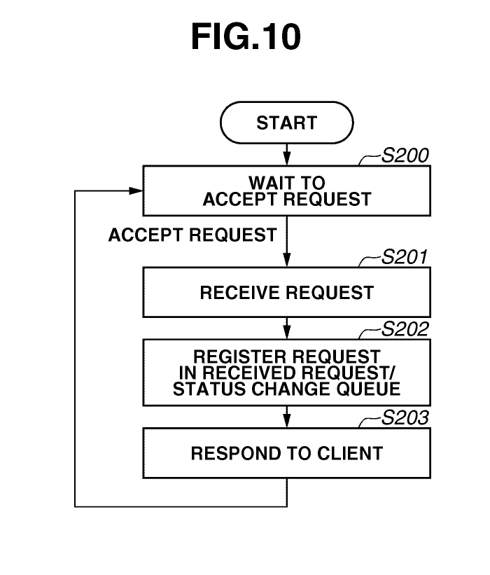

The process performed by the receiving unit 410 in the network pull-print system 102 will be described below with reference to the flowchart illustrated in FIG. 10.

In step S200, the receiving unit 410 waits to receive a request from the image forming apparatus 104, i.e., the network pull-print client. In step S201, upon accepting a new connection, the receiving unit 410 receives the transmission request. In step S202, the receiving unit 410 registers in the received request/status change queue 411, the queue message in which request content information is registered. In step S403, upon completing the registration of the queue message, the receiving unit 410 responds to the image forming apparatus 104 with the processing result, the print data acquisition request URL, and the receiving order of the print request.

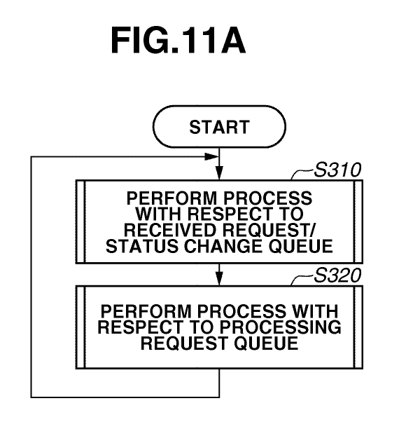

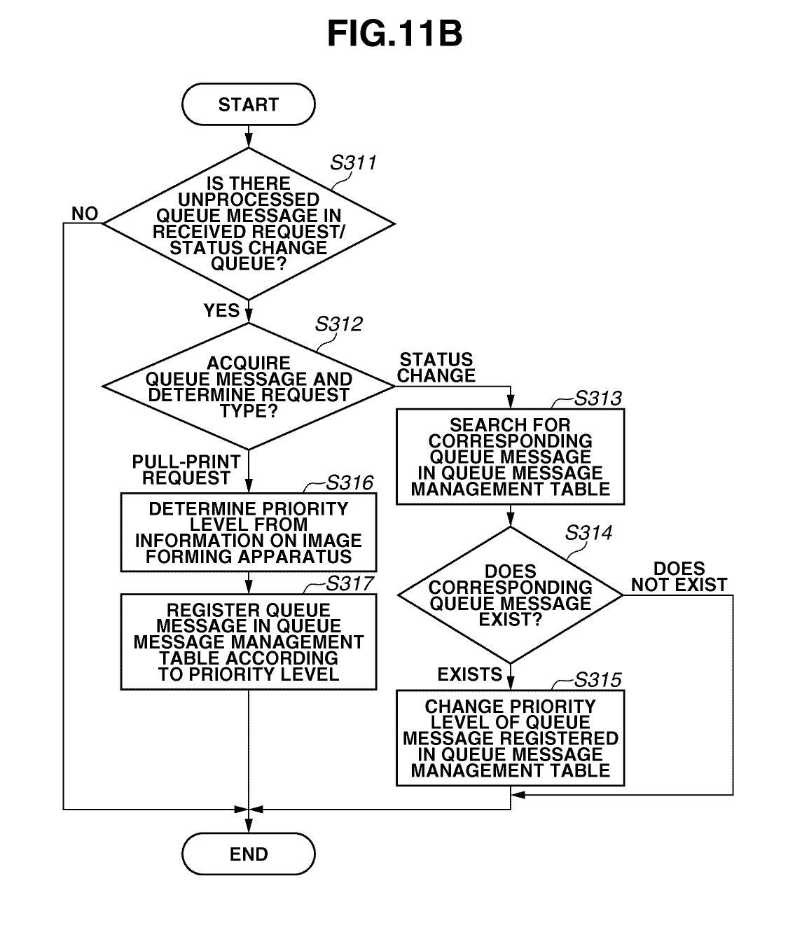

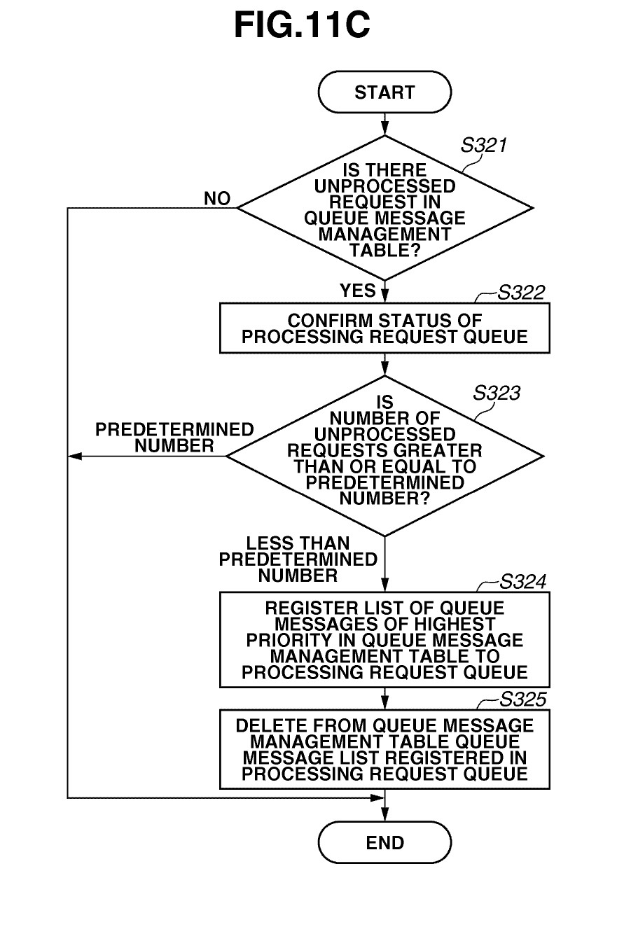

The process performed by the queue message scheduler 412 in the network print system 102 will be described below with reference to FIGS. 11A, 11B, and 11C. The queue message scheduler 412 alternately performs a process with respect to the received request/status change queue 411 in step S310 and a process with respect to the processing request queue (414) in step S320 as illustrated in FIG. 11A.

The process with respect to the received request/status change queue 411 performed by the queue message scheduler 412 in the network print system 102 will be described below with reference to FIG. 11B. In step S311, the queue message scheduler 412 determines whether there is an unprocessed queue message in the received request/status change queue 411. If there is no unprocessed queue message (NO in step S311), there is no new request, so that the queue message scheduler 412 does not perform any process.

On the other hand, if there is an unprocessed queue message (YES in step S311), the process proceeds to step S312. In step S312, the queue message scheduler 412 acquires the message from the queue, and determines a processing request type described in the message. The processing request type indicates whether the request is the network pull-print request for performing printing, or the status change notification of the client.

If the processing request type is the print request (PULL-PRINT REQUEST in step S312), the process proceeds to step S316. In step S316, the queue message scheduler 412 acquires the information on the image forming apparatus 104 from the queue message, and determines the priority of performing the print request.

The priority of the print request is determined as described below. For example, it is assumed that the status of the image forming apparatus is used as the information on the image forming apparatus 104 and that there are two levels of priority. In such a case, if the image forming apparatus is ready to print, the queue message scheduler 412 sets the priority at the highest level. On the other hand, if the image forming apparatus cannot print, the queue message scheduler 412 sets the priority at the lowest level. Further, an expected output time of the print request job of the image forming apparatus can be used as the information on the image forming apparatus 104 as follows. The queue message scheduler 412 sets the priorities based on the expected output time of the job set at 0 minutes, within 5 minutes, within 10 minutes, within 15 minutes, etc., i.e., for every 5 minutes. For example, the queue message scheduler 412 sets priority 1 to the job whose expected output time is 0 minutes, priority 2 to the job whose expected output time is within 5 minutes, and priority 3 to the job whose expected output time is within 15 minutes.

In step S317, upon determining the priority at which the print request is to be processed, the queue message scheduler 412 registers the queue message in the queue message management table 413 according to the priority.

The queue message management table 413 stores the queue message lists according to the priorities of the queue messages. The queue message list can only store a predetermined number of queue messages. The queue message scheduler 412 issues the requests to the processing request queue 414 by the unit of the queue message list in the queue message management table 413. If the queue message cannot be registered in the desired queue message list in the queue message management table 413 according to the priority, the queue message scheduler 412 registers the queue message in the list of a lower priority.

On the other hand, if the processing request type is determined to be the status change notification (STATUS CHANGE in step S312), the process proceeds to step S313. In step S313, the queue message scheduler 412 acquires from the queue message the requester information and the receiving order. The queue message scheduler 412 then searches for the corresponding queue message in the queue message management table 413 based on the receiving order. In step S314, if it is determined as a result of searching that the corresponding queue message exists (EXIST in step S314), the process proceeds to step S315. In step S315, the queue message scheduler 412 changes the priority of the queue message registered in the queue message management table 413. If the corresponding queue message does not exist (NOT EXIST in step S314), the queue message scheduler 412 ends the process.

The process performed by the queue message scheduler 412 in the network pull-print system 102 with respect to the processing request queue 414 will be described below with reference to FIG. 11C.

In step S321, the queue message scheduler 412 confirms whether there is an unprocessed request in the queue message management table 413. If there is no unprocessed request (NO in step S321), there is no new request, so that the queue message scheduler 412 does not perform any process. On the other hand, if there is an unprocessed request (YES in step S321), the process proceeds to step S322. In step S322, the queue message scheduler 412 confirms the status of the processing request queue. The status of the processing request queue indicates, for example, the number of unprocessed requests in the processing request queue. In step S323, the queue message scheduler 412 confirms, as a result of confirming the processing request queue, whether the status of the processing request queue satisfies a predetermined condition, such as whether there is a predetermined number or more of the unprocessed requests.

If there are a predetermined number of unprocessed requests (PREDETERMINED NUMBER in step S323), the queue message scheduler 412 does not perform any process with respect to the processing request queue 414. It is because, if a new request is registered regardless of a predetermined number of unprocessed requests remaining in the queue message management table 413, it is likely that the subsequently added request is processed before the previously input request. On the other hand, if there is no predetermined number of unprocessed requests (NO PREDETERMINED NUMBER in step S323), the process proceeds to step S324. In step S324, the queue message scheduler 412 acquires from the queue message list registered in the queue message management table 413 the list of highest priority. The queue message scheduler 412 then registers the queue message registered in the acquired list, in the processing request queue 414. In step S325, the queue message scheduler 412 deletes the acquired queue message list from the queue message management table 413. The process then ends.

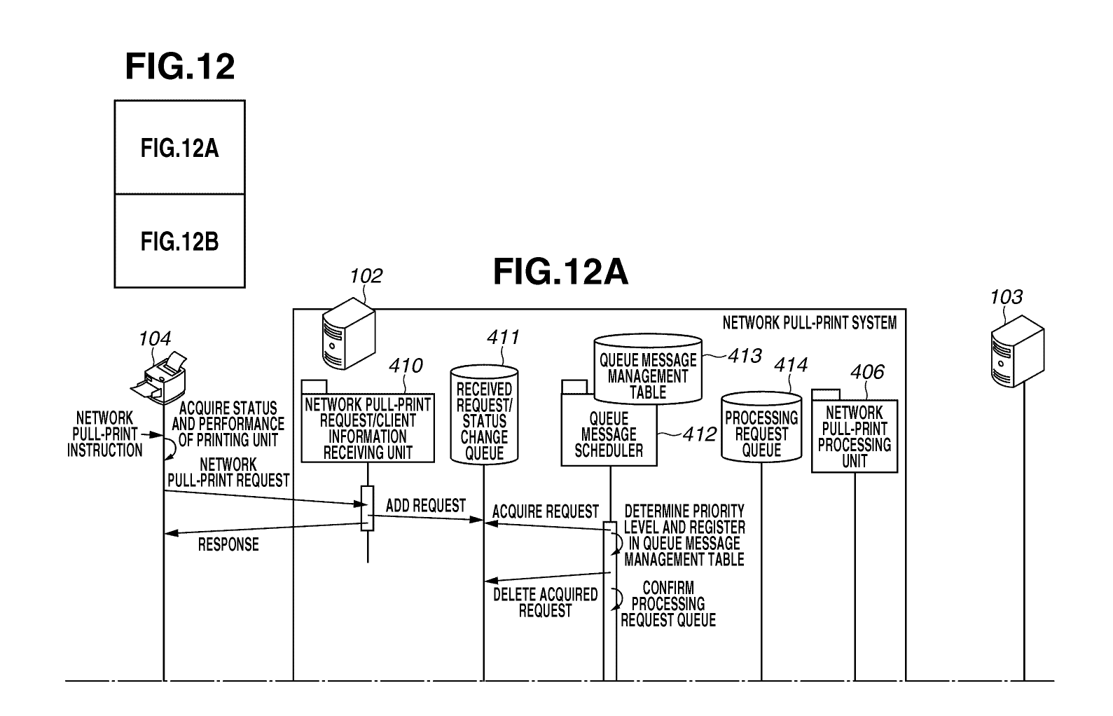

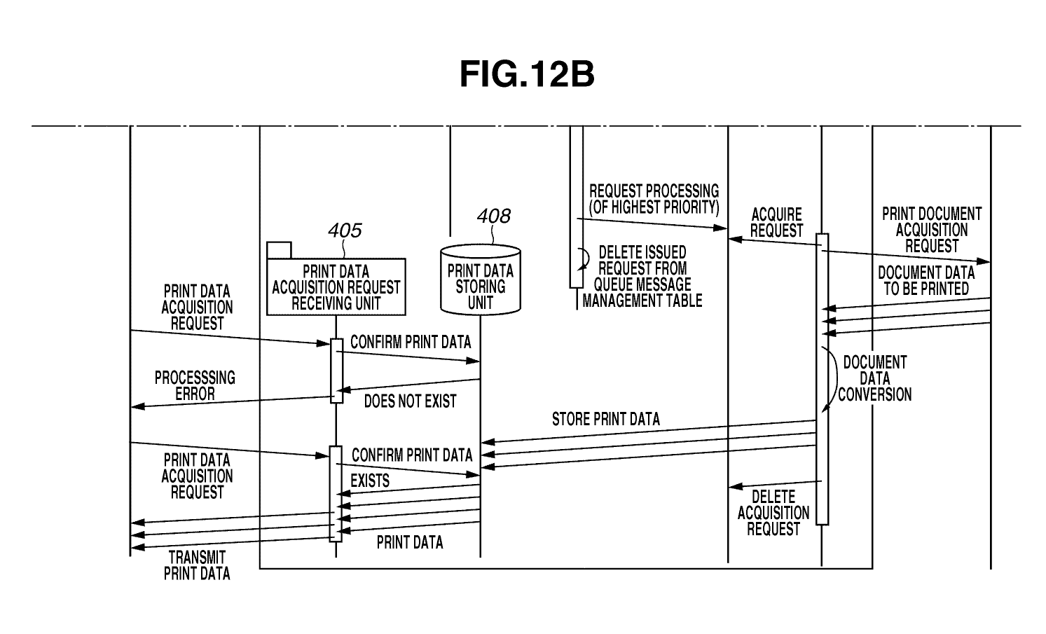

FIG. 12 is a sequence diagram illustrating a flow of the network pull-printing process performed in the system according to the present exemplary embodiment. The sequence diagram illustrates a flow from the image forming apparatus 104 receiving the network pull-print request from the user to completion of printing.

The present invention may be realized by supplying software (program code) for realizing the functions of the above-described exemplary embodiment to a system or an apparatus via a network or a storage medium, and a computer (i.e., a CPU or a micro-processing unit (MPU)) of the system or the apparatus reading and executing the program code.

According to the above-described exemplary embodiment, the requests can be processed in the receiving order even in a system which does not process the request in the receiving order such as in the queue of the cloud computing system. Further, if the requests are received at the same time from a plurality of clients, the priority of processing the requests received from the clients is automatically determined in the server according to the status of the clients. The waiting time of the clients can thus be minimized.

The present invention is not limited to a specific exemplary embodiment and may be modified and changed within the range of the present invention described in the scope of the invention.

For example, according to the first exemplary embodiment, the queue message scheduler 412 determines the priority according to the receiving order and the information on the image forming apparatus 104. However, the queue message scheduler 412 may determine the priority based only on the receiving order. As a result, the requests can be processed in the receiving order even in a system which does not process the request in the receiving order such as in the queue of the cloud computing system.

Further, the queue message scheduler 412 determines the priority according to the receiving order and the information on the image forming apparatus 104. As a result, if the requests are received from a plurality of clients (image forming apparatuses) at the same time, the priority of processing the requests from the clients is automatically determined in the network pull-print system 102 according to the status of the clients. The waiting time of the clients can thus be minimized.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In an example, a computer-readable medium may store a program that causes an apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-227576 filed Oct. 7, 2010, which is hereby incorporated by reference herein in its entirety.

What is claimed is:

1. A cloud computing system which includes a request receiving unit realized by executing a request receiving program that causes a storing service to store a message corresponding to a job according to reception of a processing request of the job from an image forming apparatus, and a back-end processing unit realized by executing a back-end processing program that regularly issues to the storing service an acquisition request for the message, and performs, in response to acquiring the message from the storing service, a process based on the acquired message, the cloud computing system comprising:
a registration unit configured to acquire a queue message issued according to a network pull-print request accepted by the request receiving unit from an image forming apparatus, determine a priority of the acquired queue message according to a status of the image forming apparatus, and register the queue message in request management data; and
an instruction unit configured to acquire a queue message of high priority from queue messages registered by the registration unit and instruct the storing service to store the acquired queue message of high priority.

2. A cloud computing system including a plurality of server computers communicable with a plurality of image forming apparatuses via a network, the system comprising:
a receiving unit configured to notify, in response to receiving a network pull-print request from an image forming apparatus, a received request queue, of a queue message of a network pull-print request whose receiving order is registered;
a scheduling unit configured to acquire a queue message from a received request queue, determine a priority of the queue message so that a priority becomes higher as a receiving order is earlier, based on a receiving order registered in the acquired queue message, register the queue message in request management data based on the determined priority, acquires, if a status of a processing request queue satisfies a predetermined condition, the queue message of highest priority from the request management data, and add to the processing request queue; and
a network pull-print processing unit configured to acquire a queue message from the processing request queue, acquire a document designated by the acquired queue message, and convert the acquired document to a data format printable by an image forming apparatus.

3. The cloud computing system according to claim 2, wherein the request management data stores a data list which groups a plurality of queue messages, according to priorities, and
wherein the scheduling unit registers the queue message in the data list of the request management data based on the determined priority, acquires, if a status of the processing request queue satisfies a predetermined condition, a data list of highest priority from the request management data, and adds queue messages included in the acquired data list to the processing request queue.

4. The cloud computing system according to claim 3, wherein the receiving unit notifies, in response to receiving a network pull-print request and image forming apparatus information from an image forming apparatus, the received request queue, of a queue message of a network pull-print request in which a receiving order and the image forming apparatus information are registered,
and wherein the scheduling unit acquires a queue message from a received request queue, and determines a priority of the queue message based on a receiving order and the image forming apparatus information registered in the acquired queue message.

5. The cloud computing system according to claim 4, wherein the image forming apparatus information is information indicating a status of a printing unit in an image forming apparatus, and
wherein the scheduling unit determines, if the image forming apparatus information registered in the acquired queue message indicate that the printing unit is ready to print, a priority that is higher than when image forming apparatus indicates that the printing unit is not ready to print.

6. The cloud computing system according to claim 5, wherein the receiving unit notifies, in response to receiving a status change notification including a receiving order from an image forming apparatus, the received request queue, of a queue message of the status change notification, and
wherein the scheduling unit acquires a queue message from the received request queue, searches, if the acquired queue message is a queue message of the status change notification, for a corresponding queue message in the request management data based on a received order included in the status change notification, and changes, if the corresponding queue message exists, a priority of the queue message according to content of the status change notification.

7. An information processing method performed by a cloud computing system including a plurality of server computers communicable with a plurality of image forming apparatuses via a network, the method comprising:
notifying, in response to receiving a network pull-print request from an image forming apparatus, a received request queue, of a queue message of a network pull-print request whose receiving order is registered;
performing scheduling by acquiring a queue message from a received request queue, determining a priority of the queue message so that a priority becomes higher as a receiving order is earlier, based on a receiving order registered in the acquired queue message, registering the queue message in request management data based on the determined priority, acquiring, if a status of a processing request queue satisfies a predetermined condition, the queue message of highest priority from the request management data, and adding the queue message to the processing request queue; and
network printing by acquiring a queue message from the processing request queue, acquiring a document designated by the acquired queue message, and converting the acquired document to a data format printable by an image forming apparatus.

8. A non-transitory computer-readable medium storing a program for causing a computer in a cloud computing system including a plurality of server computers communicable with a plurality of image forming apparatuses via a network to execute the information processing method according to claim 7.
